(19) United States
(12) Patent Application Publication
(10) Pub. No.: US 2026/0167280 A1
(43) Pub. Date: Jun. 18, 2026

(54) CONTROL OF VEHICLE AERODYNAMIC ASSEMBLY HAVING PASSIVE DEPLOYMENT MECHANISM

(71) Applicant: GM GLOBAL TECHNOLOGY OPERATIONS LLC, Detroit, MI (US)

(72) Inventors: Nathaniel J. Zavitz, Port Hope (CA); Ian Lind, Brighton, MI (US); Martin Juhas, Oshawa (CA); Mohamed Daoud, Markham (CA)

(73) Assignee: GM GLOBAL TECHNOLOGY OPERATIONS LLC, Detroit, MI (US)

(21) Appl. No.: 18/982,376

(22) Filed: Dec. 16, 2024

(51) Int. Cl. B62D 37/02; B62D 35/00

(52) U.S. Cl. CPC B62D 37/02; B62D 35/007

(57) ABSTRACT

A system for controlling operation of a vehicle includes a controller having a processor and tangible, non-transitory memory on which instructions are recorded. The vehicle includes an aerodynamic assembly with a wing. A passive deployment mechanism is adapted to control a respective position of the wing. The controller is adapted to trigger an actuator in the passive deployment mechanism to move the wing from a deployed position to a retracted position based in part on sensor data. The controller is adapted to determine an actual value of a designated parameter and an expected value of the designated parameter. The controller is adapted to determine an offset factor between the actual value and the expected value and whether the offset factor exceeds a first error threshold. Operation of the vehicle is controlled when the first error threshold is exceeded, including selective execution of a remedial action.

### INTRODUCTION

The present disclosure relates generally to a system and method of controlling operation of a vehicle having an aerodynamic assembly with a wing and a passive deployment mechanism. A passive deployment mechanism may adjust the aerodynamic profile of a vehicle by extending and retracting various control surfaces based on sensor data and control algorithms. The passive deployment mechanism operates automatically without direct driver input, allowing a vehicle to optimize its performance across a wide range of operating conditions. Due to various issues, such as the number of structural components, diagnosing degradation issues in a passive deployment mechanism in a vehicle is a complex and challenging endeavor.

### SUMMARY

Disclosed herein is a system for controlling operation of a vehicle having an aerodynamic assembly with a wing. One or more sensors are adapted to obtain sensor data related to the aerodynamic assembly. A passive deployment mechanism is located in the aerodynamic assembly. The passive deployment mechanism includes a gas spring biasing the wing towards a deployed position, and an actuator. The system includes a controller having a processor and tangible, non-transitory memory on which instructions are recorded. The controller is adapted to trigger the actuator to move the wing from the deployed position to a retracted position based in part on the sensor data.

The controller is adapted to determine an actual value of a designated parameter based in part on the sensor data and an expected value of the designated parameter. The controller is adapted to determine an offset factor between the actual value and the expected value and whether the offset factor exceeds a first error threshold. Operation of the vehicle is controlled when the first error threshold is exceeded, including selective execution of a remedial action.

The gas spring is in an extended position when the wing is in the retracted position. In some embodiments, the designated parameter is an amount of current consumed by the actuator for moving the wing from the deployed position to the retracted position. In other embodiments, the designated parameter is a time required for the wing to transition from the deployed position to the retracted position. The sensor data may include lateral acceleration, longitudinal acceleration, yaw rate and speed of the vehicle.

The vehicle may include an enhanced performance mode and a regular driving mode such that the remedial action includes blocking activation of the enhanced performance mode. The remedial action may include limiting a maximum speed of the vehicle. The remedial action may include disabling the gas spring in the passive deployment mechanism. The controller may be adapted to diagnose a first degradation level, a second degradation level and a third degradation level, respectively, for the passive deployment mechanism when the first error threshold, a second error threshold and a third error threshold is exceeded. It is understood that the number of degradation levels or thresholds may be varied based on the application at hand.

Disclosed herein is a method of controlling operation of a vehicle having an aerodynamic assembly with a wing, and a controller with a processor and tangible, non-transitory memory on which instructions are recorded. The method includes obtaining sensor data via one or more sensors operatively connected to the aerodynamic assembly. The method includes embedding a passive deployment mechanism in the aerodynamic assembly for controlling a respective position of the wing, the passive deployment mechanism having a gas spring and an actuator, the gas spring biasing the wing towards a deployed position. The method further includes triggering the actuator to move the wing from the deployed position to a retracted position based in part on the sensor data, via the controller. The method includes determining an actual value of a designated parameter based in part on the sensor data and a predefined expected value of the designated parameter, via the controller. The method includes determining an offset factor between the actual value and the predefined expected value and whether the offset factor exceeds a first error threshold, via the controller. The method includes controlling operation of the vehicle when the first error threshold is exceeded, including selectively executing a remedial action, via the controller.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary partly sectional view of a system for operating an aerodynamic assembly in a vehicle having a passive deployment mechanism and a controller, the aerodynamic assembly being in a deployed or deployed position;

FIG. 2 is a schematic fragmentary sectional view of the aerodynamic assembly of FIG. 1, with the aerodynamic assembly shown in a retracted or retracted position; and

FIG. 3 is a flowchart for a method executable by the controller of FIG. 1.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

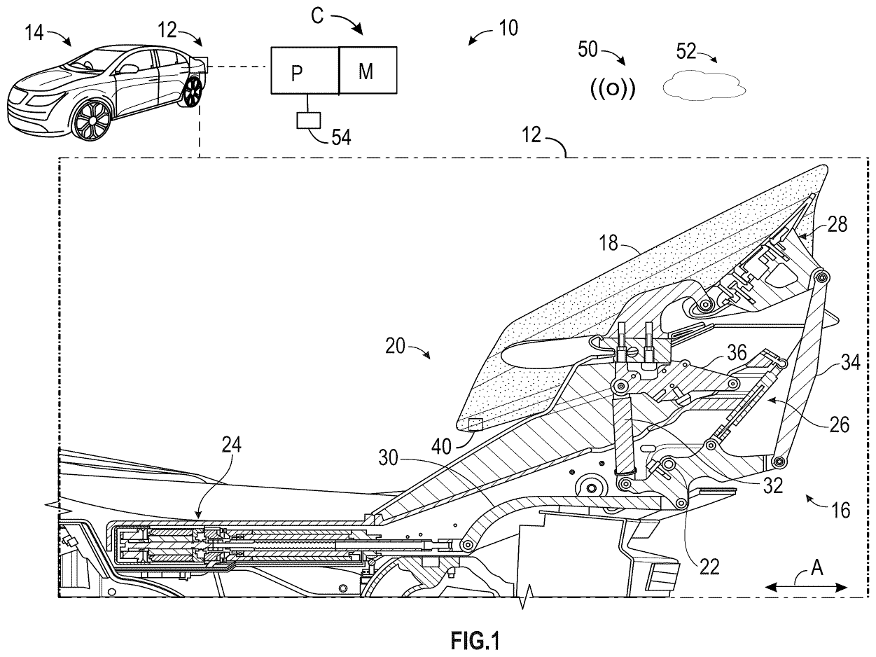

Referring to the drawings, wherein like reference numbers refer to like components, FIG. 1 schematically illustrates a system 10 for controlling operation of an aerodynamic assembly 12 in a vehicle 14. The aerodynamic assembly 12 is generally located towards the rear of the vehicle 14. The vehicle 14 may include, but is not limited to, a passenger vehicle, sport utility vehicle, light truck, heavy duty vehicle, minivan, bus, transit vehicle, bicycle, moving robot, farm implement (e.g., tractor), sports-related equipment (e.g., golf cart), boat, plane, train or another moving platform. The vehicle 14 may be an electric vehicle. It is to be understood that the vehicle 14 may take many different forms and have additional components.

Referring to FIG. 1, the system 10 includes a passive deployment mechanism 16 that automatically controls the positioning of an aerodynamic structure in the aerodynamic assembly 12, referred to herein as wing 18. The wing 18 is a structure designed to reduce drag and generate lift. The shape of the wing 18 forces air to travel different distances over top and bottom surfaces. For example, air moving under the curved surface of the wing 18 will travel faster to meet at the trailing edge. Faster moving air creates lower pressure underneath while slower moving air above creates higher pressure. The pressure difference creates a downforce or negative lift, which pushes the vehicle 14 down. This is favorable, especially when the vehicle 14 is at high speed. In the embodiment shown in FIG. 1, the wing 18 has a curved upper surface that is relatively longer and a relatively flatter or less curved lower surface. However, it is understood that the exact shape and configuration of the wing 18 may be varied based on the application at hand.

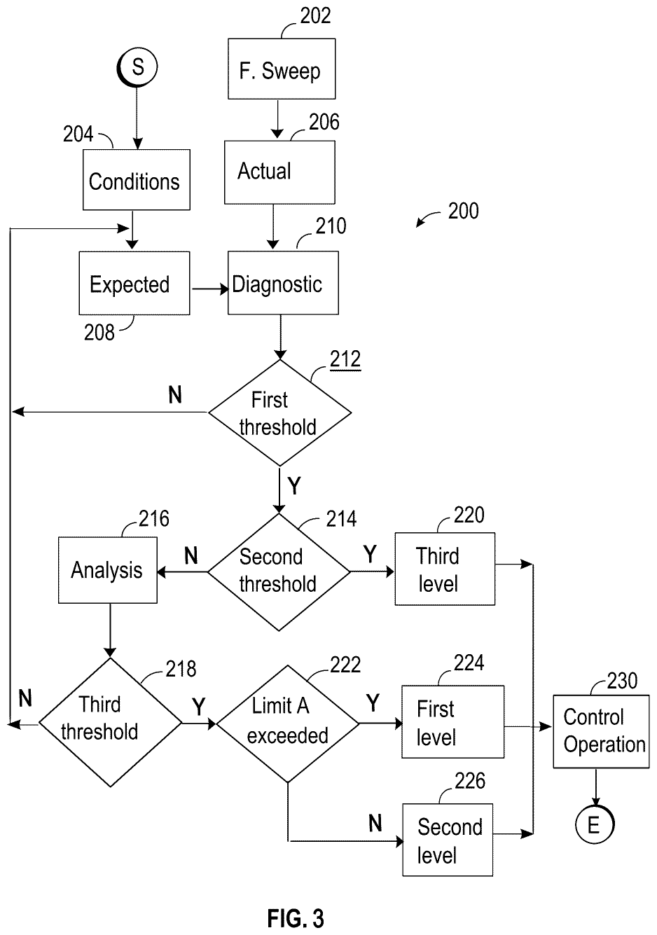

Referring to FIG. 1, the system 10 includes a controller C having at least one processor P and at least one memory M (or non-transitory, tangible computer readable storage medium on which instructions may be recorded for a method 200 for controlling operation of the aerodynamic assembly 12, described below with respect to FIG. 3. The memory M may store controller-executable instruction sets, and the processor P may execute the controller-executable instruction sets stored in the memory M.

Diagnosing degradation in the passive deployment mechanism 16 is a challenging endeavor, requiring various complex steps such as, for example, conducting structural inspections. As described below, the system 10 utilizes indirect measurements to assess the hardware components in the passive deployment mechanism 16, along with a remedial state strategy. This approach provides the technical advantage of eliminating direct measurement of hardware components. The remedial state strategy includes addressing multiple levels of vehicle performance degradation, based on the severity of the loss of capability. Additionally, performance degradation diagnostics with validation data obtained by the system 10 may be used to accurately estimate the remaining life of the hardware components in the passive deployment mechanism 16.

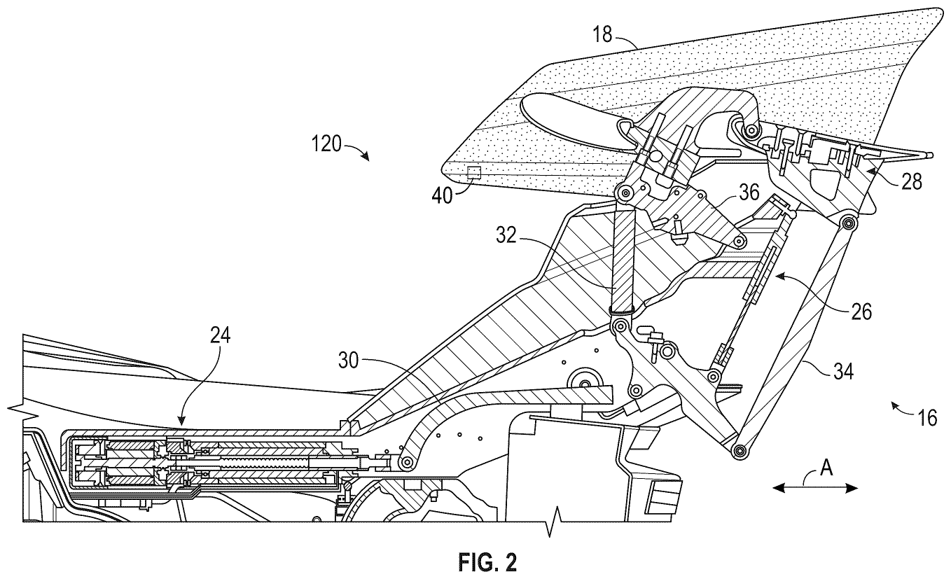

The resting state or nominal state of the wing 18 is a deployed position 20, shown in FIG. 1. Referring to FIGS. 1-2, passive deployment mechanism 16 includes an actuator 24, a gas spring 26 and a driving element 28, which are connected via a plurality of connectors, such as connectors 30, 32, 34, 36. For clarity, some components have been omitted from FIGS. 1-2. It is to be understood that the passive deployment mechanism 16 may take different forms and have additional components.

The passive deployment mechanism 16 is adapted to rotate or move the wing 18 between a deployed position 20 (shown in FIG. 1) and a retracted position 120 (shown in FIG. 2), relative to a pivot point 22. The gas spring 26 and actuator 24 work synergistically to control the movement of the wing 18 between the deployed position 20 and the retracted position 120. The gas spring 26 stores potential energy during deployment, releasing this energy in a controlled manner during retraction. The gas spring 26 biases the wing 18 towards the deployed position 20, shown in FIG. 1. When the actuator 24 is powered, it works against both the gas spring 26 and the aerodynamic moment of the wing 18 to move the wing 18 to the retracted position 120 shown in FIG. 2. Referring to FIG. 2, the gas spring 26 is extended in the retracted position 120, and the wing 18 is approximately horizontal, providing a low drag configuration. Referring to FIG. 1, the gas spring 26 is retracted in the deployed position 20.

Referring to FIG. 1, the wing 18 is typically angled or tilted in the deployed position 20. Here, the wing 18 is positioned at an angle of attack that maximizes lift generation, e.g., between 15-30 degrees from a horizontal axis A. Referring to FIG. 2, the wing 18 generally is closer to the horizontal axis A or substantially parallel to the vehicle body in the retracted position 120. Here, the wing 18 is positioned to minimize drag and reduce its profile.

The system 10 provides an indirect measurement of the capability of the gas spring 26 with a methodology to achieve a continuous and accurate reading. The gas spring 26, sometimes referred to as a gas strut or a gas damper, includes a coiled metal spring designed to shrink in height and store energy. When the coils are released, the metal spring lengthens and energy is released, pushing the aerodynamic assembly 12 into its “high downforce” position. It is understood that other mechanisms of motion control available to those skilled in the art may be employed.

The controller C may receive sensor data from at least one sensor 40 (e.g., an inertial measurement unit) positioned on or about the aerodynamic assembly 12. It is understood that the location of the sensor 40 may be varied based on the application at hand. The sensor data includes the position, speed and acceleration of the aerodynamic assembly 12. The controller C processes the sensor data and triggers the actuator 24 to deploy aerodynamic surfaces in the aerodynamic assembly 12 as needed. It is understood that the sensors 40 may incorporate other types of technologies available to those skilled in the art. In some embodiments, the actuator 24 employs an electromechanical system with at least one electric motor to drive the deployment/retraction of the wing 18. The actuator 24 may employ a hydraulic system using pressurized fluid for power. In other embodiments, the actuator 24 may employ a pneumatic system using compressed air to drive the deployment/retraction.

As described below, the controller C is adapted to determine an expected value of a designated parameter, an actual value of the designated parameter and an offset factor between the actual value and the expected value. In one embodiment, the designated parameter is the amount of current drawn by the actuator 24 to move the wing 18 from the deployed position 20 to the retracted position 120. In another embodiment, the designated parameter is the time required for the wing 18 to transition from the deployed position 20 to the retracted position 120. Operation of the vehicle 14 is controlled based in part on the offset factor. Additionally, the controller C is adapted to detect foreign objects on the wing 18. For example, if an object such as ice was stuck on the wing 18, the anticipated or expected amount of downforce would not be present.

Referring to FIG. 1, the various components of the system 10 may communicate through a wireless network 50. The controller C is in communication with a remotely located cloud computing service 52. The cloud computing service 52 may include one or more remote servers hosted on the Internet to store, manage, and process data. The cloud computing service 52 may be at least partially managed by personnel at various locations.

The vehicle 14 may include a telematics module 54 for aiding two-way communications with the cloud computing service 52, shown in FIG. 1. The telematics module 54 may collect telemetry data, such as location, speed, and servicing requirements, by interfacing with various internal sub-systems of the vehicle 14. The telematics module 54 may enable vehicle-to-vehicle communication (V2V) and/or a vehicle-to-everything communication (V2X).

Referring now to FIG. 3, an example flowchart of the method 200 is shown, which may be dynamically executed and need not be applied in the specific order recited herein. Method 200 may be executed in real-time, continuously, systematically, sporadically and/or at regular intervals, for example, each 10 milliseconds during normal and ongoing operation of the vehicle 14. Method 200 may be embodied as computer-readable code or instructions stored on and partially executable by the controller C of FIG. 1. Furthermore, it is to be understood that some steps may be eliminated.

Method 200 begins at blocks 202 and 204. Per block 202, the controller C is adapted to perform a functional sweep or initialization of the passive deployment mechanism 16, including monitoring current consumption. Also, per block 202, the controller C is adapted to obtain sensor data such as the speed of the vehicle, the lateral acceleration, the longitudinal acceleration, yaw rate, lift coefficient, ambient temperature, the density of air etc. The controller C is adapted to obtain calibrated data, including the surface area of the wing 18, the length of the gas spring arm and the length of the wing arm.

Per block 204, the controller C is adapted to determine whether one or more enablement preconditions are satisfied. For example, the precondition may be confirming that the steering angle of the vehicle 14 is below a predefined threshold, i.e., requiring a maximum steering angle or maximum lateral acceleration. If the precondition is not satisfied, the data obtained from the measurements or sensor data is discarded.

Advancing from block 202 to block 206, the controller C is adapted to calculate an actual value of a designated parameter. In another embodiment, the designated parameter is the time required for the wing 18 to transition from the deployed position 20 to the retracted position 120. The actual time may be obtained through sensor data. In another embodiment, the designated parameter is the amount of current drawn by the actuator 24 to move the wing 18 from the deployed position 20 to the retracted position 120. The current drawn may be obtained through the sensor data.

Advancing from block 204 to block 208, the controller C is adapted to an expected value of the designated parameter. The expected value is based in part on data obtained from manufacturer. The expected time (for the wing 18 to transition between positions) is based on a number of factors, including the velocity of the vehicle 14, the nominal force of the gas spring 26, angular momentum, moment of inertia, lift coefficient, total torque and the density of air (which is a function of temperature). Based on the application at hand, the expected time may be determined in a number of ways. Several examples are described below. In one embodiment, the expected time is calculated as

$$[ \frac{- {v}_{0} + 2 {( {v}_{0}^{2} + 2 ax )}^{1 / 2}}{a} ] ,$$

where a is the average acceleration, v₀ is the initial velocity and x is a distance. In another embodiment, the expected time may be calculated as

$$[ \frac{- \dot{θ} + {( {\dot{θ}}^{2} + 2 \ddot{θ} θ )}^{1 / 2}}{\ddot{θ}} ] ,$$

where \ddot{θ} is the average angular acceleration, \dot{θ} is the average angular velocity and θ is an angular position.

The expected time may be calculated based on tabulated values (e.g., a look-up table) used on new hardware as a function of load (vₓ, ρ, T, aₓ, a_{z}) compared to various measured times. Additionally, given a target time to achieve a target position, the controller C may be adapted to designate a system fault status if the measured time is greater than the target time. If the measured time is greater than the target time multiplied by a coefficient that is less than 1, the controller C may be adapted to designate a degraded status.

In some embodiments, the expected time is calculated as a product of the angular momentum and moment of inertia, divided by the total torque. The total torque is obtained by adding the gas spring torque (also referred to as strut torque) and the wing torque together. The wing torque is based on the lift coefficient (C), the density of air (φ, vehicle speed (V), the surface area (A) of the wing 18, and the length of the wing (L_{wing}), as follows:

$$Wing Torque = [ C * ρ * \frac{{V}^{2}}{2} * A ) + ( {L}_{wing} ) ] .$$

The surface area (A) of the wing 18 is based on an angle of attack, which is the angle between the chord line (an imaginary line connecting the leading and trailing edges of the wing 18) and the relative wind (the direction of the oncoming air). The gas spring torque is based on the length of the gas spring [symbol] L_{spring}), and the nominal force [symbol] F_{spring}) of the gas spring 26. The nominal force of the gas spring 26 may be obtained from the manufacturer data and represents the force expected from a nominal gas spring 26 as follows: Gas Spring Torque=[F_{spring}*L_{spring}].

From blocks 206 and 208, method 200 proceeds to block 210 to conduct diagnostic analysis, including calculating an offset factor between the actual value and the expected value. The offset factor [symbol] E_{offset}) is based on the difference between the actual and expected time as follows:

$${E}_{offset} = [ \frac{Actual time - Nominal time}{Nominal time} * 100 \% ] .$$

Advancing from block 210 to block 212, method 200 includes determining if a first error threshold is satisfied as follows: X_{first threshold}=[E_{offset}>E_{acceptable}] If the offset factor is greater than a predetermined acceptable offset (block 212=YES), method 200 advances to block 214 to determine if a second error threshold is met as follows: X_{second threshold}=[X_{first threshold}*(E_{offset}>E_{critical})]. The error thresholds (e, g., E_{acceptable}, E_{critical}) may be preset through calibration, finite element analysis and other methods.

If not (block 212=NO), the method 200 loops back to block 208. If the second error threshold is met (block 214=YES), method 200 proceeds to block 220 to establish or diagnose a third degradation level. The third degradation level is the most severe level in this example. While three degradation levels are illustrated in this embodiment, it is understood that the number of degradation levels or thresholds may be varied based on the application at hand.

If the second threshold is not met (block 214-NO), method 200 advances to block 216 to conduct statistical analysis. For example, the controller C may employ an “X of Y” filter. An X of Y filter allows a signal to pass through if at least X out of Y consecutive samples meet a specific condition (like being above a threshold). Here X is the number of failures, Y is the number of samples. This technique helps reduce noise by requiring multiple consistent readings before registering a change, providing robustness against random fluctuations.

From block 216, method 200 proceeds to block 218 to determine if a third error threshold (representing the X of Y filter) is met. In other words, if the number of failures exceeds the set number X out of Y failures. If the third threshold (representing the X of Y filter) is met (block 218=YES), method 200 proceeds to block 222 to determine if a fourth error threshold is met. If not (block 218=NO), the method 200 loops back to block 208.

The fourth error threshold may be based on a statistical analysis as follows: X_(fourth threshold)=[( [symbol] (X [symbol] _(first threshold)+1))/(Y Event)>X_(third threshold))]. Here the controller increments the failure count each time there is a failure event compared to the number of samples. Each of the error threshold levels may be preset through calibration, finite element analysis and other methods. If the fourth error threshold is met (block 222=YES), method 200 proceeds to block 224 to establish or diagnose a first degradation level. If not (block 222=NO), the method 200 advances to block 226 to establish or diagnose a second degradation level.

Advancing from blocks 220, 224, and 226 to block 230, the controller C is adapted to control operation of the vehicle 14, including selectively executing a remedial action, based on the degradation level. For example, the remedial action for the first degradation level may include limiting the speed of the vehicle 14, i.e., enforcing a maximum speed for the vehicle 14. In some embodiments, the vehicle 14 includes an enhanced performance mode (with enhanced features of speed and acceleration) and a regular mode. The remedial action for the second degradation level may include blocking the enhanced performance mode. The remedial action for the third degradation level may include disabling the gas spring 26 and displaying a warning (e.g., through an active aerodynamic lamp in this vehicle that lights up) to the vehicle operator to take a trip to the mechanic for replacing the gas spring 26. Method 200 is then ended.

Referring to FIG. 1, the wireless network 50 may be a short-range network or a long-range network. The wireless network 50 may be a communication BUS, which may be in the form of a serial Controller Area Network (CAN-BUS). The wireless network 50 may be a serial communication bus in the form of a local area network. The local area network may include, but is not limited to, a Controller Area Network (CAN), a Controller Area Network with Flexible Data Rate (CAN-FD), Ethernet, Bluetooth, WIFI and other forms of data. The wireless network 50 may be a Wireless Local Area Network (LAN) which links multiple devices using a wireless distribution method, a Wireless Metropolitan Area Network (MAN) which connects several wireless LANs or a Wireless Wide Area Network (WAN) which covers large areas such as neighboring towns and cities. Other types of network technologies or communication protocols available to those skilled in the art may be employed.

In summary, the system determines the level or severity of degradation and optimizes the performance envelope of the vehicle 14 by invoking the appropriate remedial action. The system 10 uses available data from an actively driven mechanism and surrounding environment to establish an acceptable passive deployment time and speed system that performs a fault maturation of the degraded passive deployment mechanism. The system 10 minimizes hardware requirements and enables a wider vehicle performance envelope. The system 10 enables detection of foreign object contamination of the wing 18, such as ice/snow buildup.

The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a group of files in a file rechargeable energy storage system, an application database in a proprietary format, a relational database energy management system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The flowcharts illustrate an architecture, functionality, and operation of possible implementations of systems, methods, and computer program products of various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based storage systems that perform the specified functions or acts, or combinations of specific purpose hardware and computer instructions. These computer program instructions may also be stored in a computer-readable medium that may direct a controller or other programmable data processing apparatus to function in a particular manner, such that the instructions stored in the computer-readable medium produce an article of manufacture including instructions to implement the function/act specified in the flowchart and/or block diagram blocks.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used here indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A system for controlling operation of a vehicle having an aerodynamic assembly, the system comprising:
one or more sensors adapted to obtain sensor data related to the aerodynamic assembly, the aerodynamic assembly having a wing;
a passive deployment mechanism located in the aerodynamic assembly and having a gas spring and an actuator, the gas spring biasing the wing towards a deployed position;
a controller adapted to trigger the actuator to move the wing from the deployed position to retracted position based in part on the sensor data, the controller having a processor and tangible, non-transitory memory on which instructions are recorded;
wherein the controller is adapted to:
determine an actual value of a designated parameter based in part on the sensor data and an expected value of the designated parameter;
calculate an offset factor between the actual value and the expected value and determine whether the offset factor exceeds a first error threshold; and
control operation of the vehicle when the first error threshold is exceeded, including selectively executing a remedial action.

2. The system of claim 1, wherein the gas spring is in an extended position when the wing is in the retracted position.

3. The system of claim 1, wherein the designated parameter is an amount of current consumed by the actuator for moving the wing from the deployed position to the retracted position.

4. The system of claim 3, wherein the designated parameter is a time required for the wing to transition from the deployed position to the retracted position.

5. The system of claim 1, wherein the vehicle includes an enhanced performance mode and a regular driving mode such that the remedial action includes blocking activation of the enhanced performance mode.

6. The system of claim 1, wherein the remedial action includes limiting a maximum speed of the vehicle.

7. The system of claim 1, wherein the remedial action includes disabling the gas spring in the passive deployment mechanism.

8. The system of claim 1, wherein the controller is adapted to diagnose a first degradation level, a second degradation level and a third degradation level, respectively, for the passive deployment mechanism when the first error threshold, a second error threshold and a third error threshold is exceeded.

9. The system of claim 1, wherein the sensor data includes a lateral acceleration, a longitudinal acceleration, a yaw rate and a speed of the vehicle.

10. A method of controlling operation of a vehicle having an aerodynamic assembly with a wing, and a controller with a processor and tangible, non-transitory memory on which instructions are recorded, the method comprising:
obtaining sensor data via one or more sensors operatively connected to the aerodynamic assembly;
embedding a passive deployment mechanism in the aerodynamic assembly for controlling a respective position of the wing, the passive deployment mechanism having a gas spring and an actuator, the gas spring biasing the wing towards a deployed position;
triggering the actuator to move the wing from the deployed position to a retracted position based in part on the sensor data, via the controller;
determining an actual value of a designated parameter based in part on the sensor data and a predefined expected value of the designated parameter, via the controller;
determining an offset factor between the actual value and the predefined expected value and whether the offset factor exceeds a first error threshold, via the controller; and
controlling operation of the vehicle when the first error threshold is exceeded, including selectively executing a remedial action, via the controller.

11. The method of claim 10, further comprising:
selecting the designated parameter to be an amount of current consumed by the actuator for moving the wing from the deployed position to the retracted position.

12. The method of claim 10, further comprising:
selecting the designated parameter to be a time for the wing to move from the deployed position to the retracted position.

13. The method of claim 10, further comprising:
configuring the aerodynamic assembly such that the gas spring is in an extended position when the wing is in the retracted position.

14. The method of claim 10, wherein the vehicle includes an enhanced performance mode and a regular driving mode, further comprising:
selecting the remedial action to include blocking activation of the enhanced performance mode.

15. The method of claim 10, further comprising:
selecting the remedial action to include limiting a maximum speed of the vehicle.

16. The method of claim 10, further comprising:
selecting the remedial action to include disabling the gas spring in the passive deployment mechanism.

17. The method of claim 10, further comprising:
diagnosing a first degradation level, a second degradation level and a third degradation level, respectively, for the passive deployment mechanism when the first error threshold, a second error threshold and a third error threshold is exceeded.

18. A vehicle comprising:
an aerodynamic assembly having a wing;
one or more sensors adapted to obtain sensor data related to the aerodynamic assembly;
a passive deployment mechanism located in the aerodynamic assembly and having a gas spring and an actuator, the gas spring biasing the wing towards a deployed position;
a controller adapted to trigger the actuator to move the wing from the deployed position to retracted position based in part on the sensor data, the controller having a processor and tangible, non-transitory memory on which instructions are recorded;
wherein the gas spring is in an extended position when the wing is in the retracted position;
wherein the controller is adapted to:
determine an actual value of a designated parameter based in part on the sensor data and an expected value of the designated parameter;
determine an offset factor between the actual value and the expected value and whether the offset factor exceeds a first error threshold; and
control operation of the vehicle when the first error threshold is exceeded, including selectively executing a remedial action.

19. The vehicle of claim 18, wherein the designated parameter is an amount of current consumed by the actuator to move the wing from the deployed position to the retracted position.

20. The vehicle of claim 18, wherein the designated parameter is a time required for the wing to move from the deployed position to the retracted position.
